(19) United States
(12) Patent Application Publication
(10) Pub. No.: US 2012/0154255 A1
(43) Pub. Date: Jun. 21, 2012

(54) COMPUTING DEVICE HAVING PLURAL DISPLAY PARTS FOR PRESENTING PLURAL SPACES

(75) Inventors: Kenneth P. Hinckley, Redmond, WA (US); Michel Pahud, Kirkland, WA (US); William A. S. Buxton, Toronto (CA)

(73) Assignee: Microsoft Corporation, Redmond, WA (US)

(21) Appl. No.: 12/970,951

(22) Filed: Dec. 17, 2010

(51) Int. Cl. G09G 5/00; H04N 7/14

(52) U.S. Cl. 345/1.3; 348/14.08; 348/E07.077

(57) ABSTRACT

A computing device is described which includes plural display parts provided on respective plural device parts. The display parts define a display surface which provides interfaces to different tools. The tools, in turn, allow a local participant to engage in an interactive session with one or more remote participants. In one case, the tools include: a shared workspace processing module for providing a shared workspace for use by the participants; an audio-video conferencing module for enabling audio-video communication among the participants; and a reference space module for communicating hand gestures and the like among the participants, etc. In one case, the computing device is implemented as a portable computing device that can be held in a participant's hand during use.

### BACKGROUND

Different tools exist to facilitate interactive sessions among a group of participants. For example, video conferencing tools allow the participants to view audio-video representations of remote fellow participants. Collaborative workspace tools allow the participants to cooperatively work on shared information, such as a shared document or the like. However, these tools are often implemented as separate stationary computing equipment which may not offer a satisfactory user experience in all circumstances.

### SUMMARY

A computing device is described herein which includes plural display parts provided on plural respective device parts. For example, the computing device can include two or more device parts joined together by any type of coupling mechanism. The different display parts define a display surface. The display surface provides respective interfaces for different tools, in optional conjunction with other interface mechanism(s). The tools, in turn, allow a local participant to engage in an interactive session with one or more remote participants. In one case, the computing device is implemented as a portable computing device that can be held in a participant's hand during use.

More specifically, in one case, the computing device can include a display mechanism that implements the multi-part display, together with plural input mechanisms for receiving input events. The computing device can also provide a processing engine that provides plural processing modules. The different processing modules can provide the above-mentioned tools which allow the local participant to interact with one or more remote participants in different ways. Each remote participant may operate a remote computing device that has the same functionality as a local computing device operated by the local participant.

In one illustrative implementation, the processing modules can include any one or more of the following modules for delivering respective functionalities.

(a) Shared workspace processing module. A shared workspace processing module provides a shared workspace. That is, the shared workspace is shared by at least two participants of the interaction session. The participants can collaboratively work on a shared task using the shared workspace. That is, the participants can work on the shared workspace at the same time and/or asynchronously (e.g., at respective different times).

(b) Private workspace processing module. A private workspace processing module presents a private workspace for private use by the local participant. The private workspace processing module may allow a user to move objects from the private workspace to the shared workspace, e.g., by dragging these objects from a private display section to a shared display section of the local computing device.

(c) Audio-video conferencing module. An audio-video conferencing module captures an audio-video representation of the local participant. Further, the audio-video conferencing module displays an audio-video representation of one or more remote participants of the interaction session. In one implementation, the computing device can devote different display parts to providing representations of different respective remote participants.

(d) A reference space module. A reference space module captures a representation of local hand gestures made by the local participant in proximity to a display surface of the display mechanism. The reference space module also displays a representation of remote hand gestures made by at least one remote participant in proximity to a remote display surface associated with a remote computing device operated by the remote participant.

(e) Mode selection module. A mode selection module selects which processing modules are activated at each identified time of operation.

In one implementation, the computing device can provide at least two image sensing mechanism (of any type) at different respective locations on the computing device. This allows the computing device to define a capture frustum that projects out from the computing device.

The above functionality can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative computing device for use by participants of an interaction session.

FIG. 2 shows an illustrative system that can incorporate the computing device of FIG. 1.

FIG. 3 shows one illustrative implementation of the computing device of FIG. 1 in which the computing device includes two display parts.

FIG. 4 shows a larger-size version of the computing device of FIG. 3.

FIG. 5 shows another illustrative implementation of the computing device of FIG. 1 in which the computing device includes three display parts.

FIG. 6 shows a computing device that incorporates a depth sensing mechanism that can be aimed in a direction opposite to at least part of a display surface of the computing device.

FIGS. 7-11 show different presentations that can be provided on different display sections of a computing device.

FIG. 12 shows an example of an input gesture that can be performed which involves at least two display parts of a computing device.

FIGS. 13 and 14 show two examples of computing devices with detachable device parts.

FIG. 15 shows an example of the operation of a mode selection mechanism which toggles between different displayed content based on a relative position of a computing device.

FIG. 16 shows a flowchart which explains one manner of operation of the computing device of FIG. 1.

FIG. 17 shows an illustrative processing functionality that can be used to implement any aspect of the features shown in the foregoing drawings.

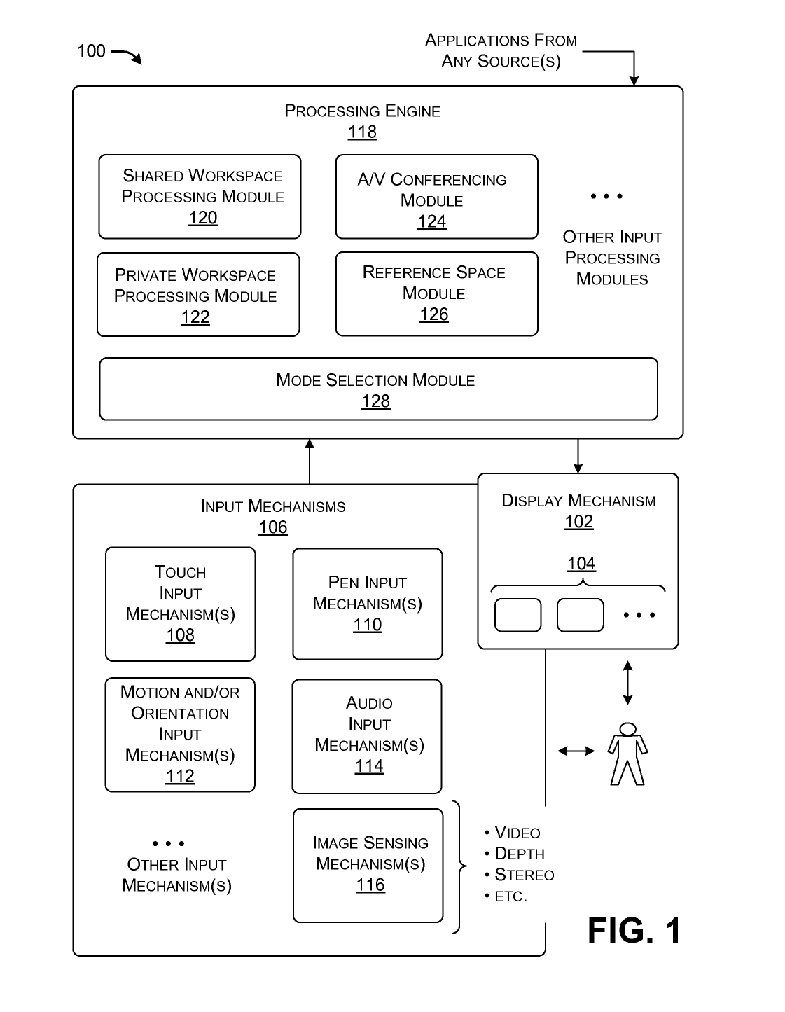

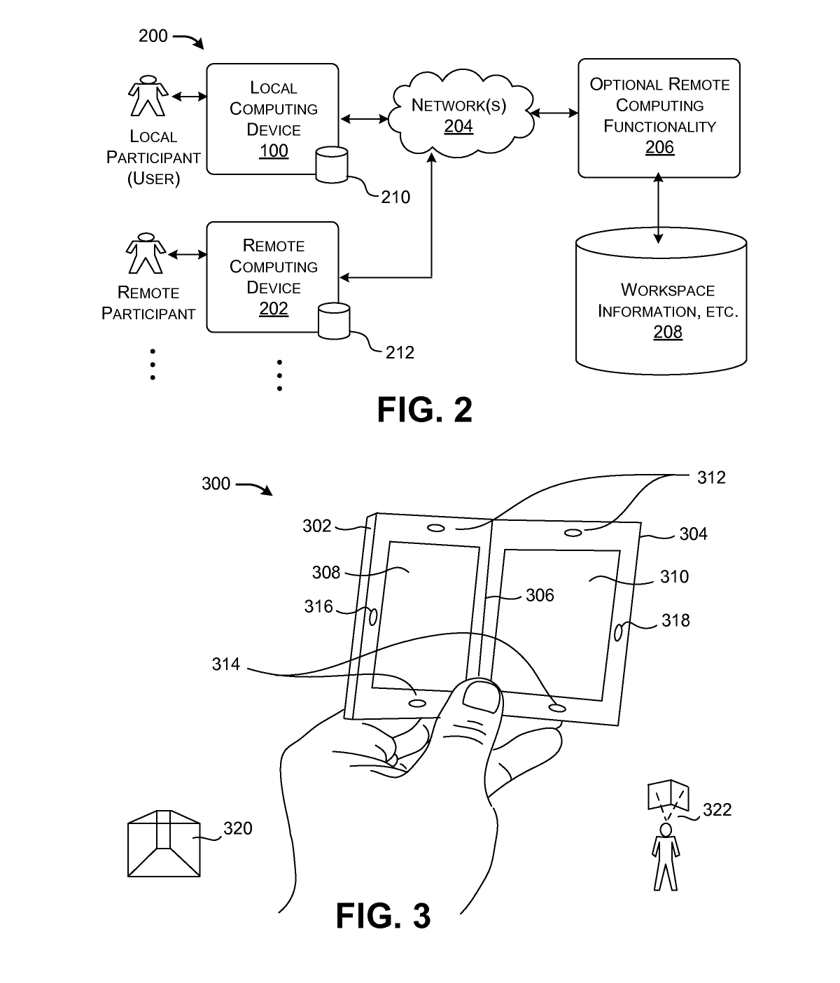

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative computing device having multiple display parts. The computer device allows a local participant to engage in an interaction session with one or more remote participants. Section B describes illustrative methods which explain the operation of the computing device of Section A. Section C describes an illustrative processing functionality that can be used to implement any aspect of the features described in Sections A and B.

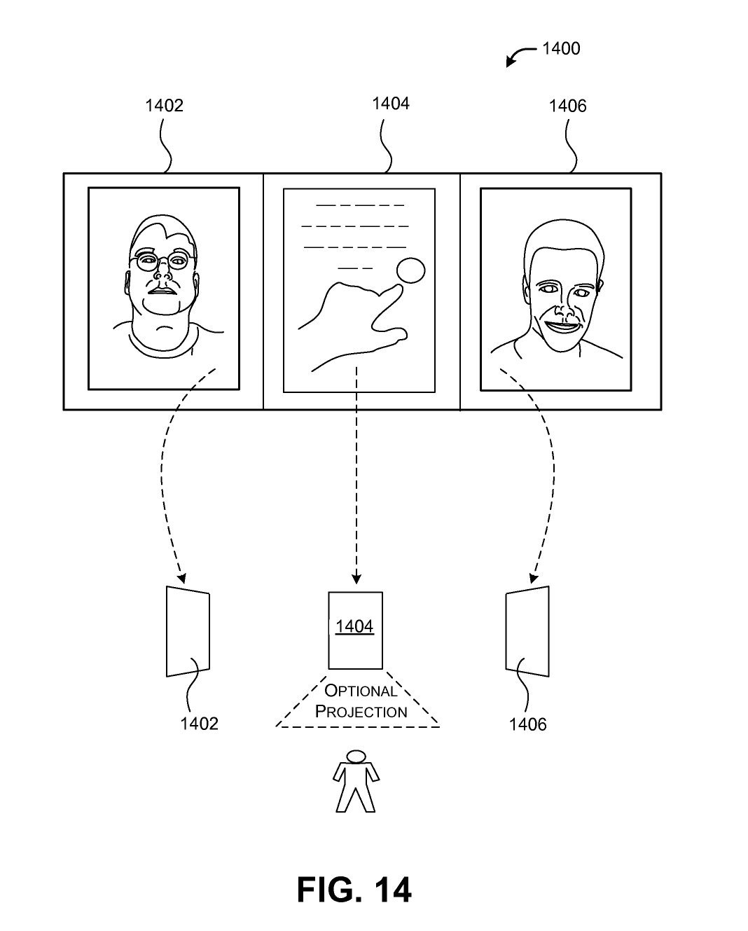

As a preliminary matter, some of the figures describe concepts in the context of one or more structural components, variously referred to as functionality, modules, features, elements, etc. The various components shown in the figures can be implemented in any manner by any physical and tangible mechanisms (such as by hardware, software, firmware, etc., or any combination thereof). In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 14, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms (such as by hardware, software, firmware, etc., or any combination thereof).

As to terminology, the phrase “configured to” encompasses any way that any kind of physical and tangible functionality can be constructed to perform an identified operation. The functionality can be configured to perform an operation using, for instance, software, hardware, firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware, firmware, etc., and/or any combination thereof. When implemented by a computing system, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Illustrative Computing Devices

FIG. 1 shows an example of a computing device 100 that can be used to interact with one or more other participants of an interaction session. The participant who interacts with the computing device 100 is referred to herein as a local participant (or a “user”), and the computer device 100 itself is referred to as a local computing device 100. The other participants are referred to herein as remote participants. Each remote participant interacts with a remote computing device having the same design and functionality as the local computing device 100.

As will be set forth in more detail with reference to FIGS. 3-5, the local computing device 100 can be composed of plural physical device parts, such as two, three, or more device parts. The local computing device 100 can join the device parts together via any type of coupling mechanism, such as a hinge mechanism, a sliding-coupling mechanism (in which the device parts can be slid apart in any manner), a detachable coupling mechanism (in which the device parts can be detached and separated, and then reattached), and so on.

The local computing device 100 includes a display mechanism 102 for displaying information on a display surface. The display mechanism 102 can include plural physical display parts 104 (depicted in only abstract form in FIG. 1). For example, the local computing device 100 can provide plural display parts on plural respective device parts. The term “display section” more broadly refers to any partitioning of display content on the display surface. For example, the display mechanism 102 can display two sections devoted to different communication roles on a single physical display part, e.g., by devoting a top half of the display part for one section and the bottom half of the display part to another section. In another implementation, one or more display sections can overlap. Although not shown, the local computing device 100 can also include an audio output mechanism, e.g., for presenting the voices of remote participants. For example, the local computing device 100 can provide a speaker (or speakers) on each device part (to be described in greater detail below). In addition, or alternatively, the local computing device 100 can provide known techniques to control the perceived directionality of audio output provided by the speaker(s). The local computing device 100 can also include a haptic (e.g., vibratory) output mechanism.

The local computing device 100 includes plural input mechanisms 106 which allow a user to input commands and other information to the local computing device 100. As used herein, the input provided by each input mechanism is referred to as an input event. For ease and brevity of reference, the following explanation will most often describe the output of an input mechanism in the plural, e.g., as “input events.” However, various analyses can also be performed on the basis of a singular input event. For example, the input mechanisms 106 can include a touch input mechanism 108 for receiving touch input events when the user proximally or physically contacts the display surface of the display mechanism 102. (Different types of input mechanisms are referred to in the singular below for brevity, although the local computing device 100 can include two or more of these types.) The input mechanisms 106 can also include a pen input mechanism 110 for providing pen input events when the user proximally or physically contacts the display surface with a pen device. The local computing device 100 can also include motion and/or orientation sensing mechanisms 112, such as any type of accelerometer device, any type of gyro device, and so on. The local computing device 100 can also include any type of audio input mechanism 114 for capturing the voice of the local participant and other audible information. For example, the audio input mechanism 114 can be implemented as an array microphone that provides localization of sound sources.

The input mechanisms 106 can also include any type of image sensing mechanism(s) 116. As used herein, the term image sensing mechanism encompasses a broad collection of possible devices. For example, the image sensing mechanism(s) 116 can include a video input mechanism for capturing a video representation of the local participant.

The image sensing mechanism(s) 116 can also include any type of depth sensing mechanism(s) for sensing the distance of objects from the local computing device 100. A depth sensing mechanism can be implemented using any technology (e.g., time-of-flight technology) in conjunction with any type of electromagnetic radiation (e.g., infrared radiation). More specifically, some of the depth sensing mechanisms can determine a general (aggregate) indication of a distance of an object from the local computing device 100. Other depth sensing mechanisms can assess the distance in a more fine-grained manner, such as by providing a per-pixel indication of the distance of an object from the local computing functionality 100, etc.

The image sensing mechanism(s) 116 can also include any type of stereo sensing mechanism for capturing stereo images of objects in proximity to the local computing device 100, e.g., in front of the local computing device 100. The image sensing mechanism(s) 116 can include yet other types of devices for capturing objects in proximity to the local computing device 100.

FIG. 1 depicts the input mechanisms 106 as partially overlapping the display mechanism 102. This is because at least some of the input mechanisms 106 may be integrated with functionality associated with the display mechanism 102. This is the case with respect to the touch input mechanism 108. Namely, the touch input mechanism 108 relies, in part, on functionality provided by the display mechanism 102.

Alternatively, or in addition, the input mechanisms 106 can include touch input mechanisms that are independent (or at least partially independent) of the display mechanism 102. These touch input mechanisms can be provided at any location(s) on the local computing device. For example, the input mechanisms 106 can include a pad-type input mechanism, also referred to as a tablet, a digitizer, a graphics pad, etc. In one implementation, the pad-type input mechanism can be integrated into the housing of the local computing device 100. Alternatively, or in addition, the pad-type input mechanism can represent functionality that is separate from the local computing device 100. A user can enter input events via the pad-type input mechanism without making contact with the display surface of the local computing device 100.

The local computing device 100 also includes a processing engine 118 that provides a number of selectable processing modules. Each processing module, in turn, provides a different tool that facilitates the local participant's communication with one or more remote participants. Without limitation, one implementation of the processing engine 118 can include the following processing modules.

A shared workspace processing module 120 provides a shared workspace that is shared by at least two participants of the interaction session. More specifically, the shared workspace presents a shared representation of a task. Each of the participants may contribute to the task in collaborative fashion, either at the same time, or consecutively, or some combination thereof. Each participant can observe the changes made by other participants based on changes that appear in the shared workspace. The shared workspace can be said to implement a “task space” of the interactive session insofar as it provides a forum for addressing a shared task.

A private workspace processing module 122 presents a workspace for private use by the local participant. More specifically, the private workspace provides a representation of a private task or private information for the user's exclusive consumption. However, the private workspace processing module 122 may allow a user to move objects from the private workspace to the shared workspace, e.g., by dragging these objects from a private display section to a shared display section of the local computing device 100. The user can also move objects from the shared workspace to the private workspace.

An audio-video conferencing module 124 captures an audio-video representation of the local participant. Further, the audio-video conferencing module 124 displays an audio-video representation of one or more remote participants of the interaction session. The audio-video conferencing module 124 can rely on the audio input mechanism 114 and the image sensing mechanism(s) 116 to provide its function. The audio-video conferencing module 124 can be said to implement a “person space” of the interactive session insofar as it presents representations of the faces and voices of people involved in the interactive session.

A reference space module 126 captures a representation of local hand gestures made by the local participant in proximity to the display surface. Further, the reference space module 126 can display a representation of remote hand gestures made by one or more remote participants in proximity to their respective remote display surfaces. In one implementation, the reference space module 126 performs this task by using a depth sensing mechanism to sense the distance of the local participant's hands (or other objects) from the display surface of the local computing device 100, e.g., as the user points to objects on the shared workspace or makes other expressive gestures with respect to the shared workspace. The reference space module 126 can then present a shadow representation of the local user's hands to other participants of the interactive session. That is, the reference space module 126 of a remote computing device may overlay the shadow representation of the local user's hands onto the shared workspace. In this manner, the remote participant can see the gestures that the local participant is making in front of the shared workspace. The reference space module 126 can be said to implement a “reference space” because it provides visual cues regarding pointing gestures and other expressive actions made by users which relate to the ongoing interactive session. Demonstrations presented in reference space can be recorded for later playback. Hence, the reference space module 126 can provide reference cues in both a synchronous collaborative mode (in which two or more participants are communicating in real time), and in an asynchronous playback mode, or both modes.

The gesture representation of a user's hands (or other body parts or articles), can be formed in any manner. In one case, the gesture representation corresponds to a filtered version of raw image sensing data, e.g., collected from depth sensing mechanism(s). Alternatively, or in addition, the reference space module 126 can recognize and track the user's hands (and/or other body parts or reference objects). The reference space module 126 can then represent the user's hands (and/or other body parts or reference objects) in any manner, such as by provided a skeletal representation, an animated representation, an avatar-type representation, and so on.

A mode selection module 128 selects which processing module or modules are activated at each identified time of operation. The mode selection module 128 can perform this role based on one or more selection factors. In one case, the mode selection module 128 can select processing modules based on the expressed instructions of the local participant. Further, the mode selection module 128 can allow the local participant to choose the display sections of the local computing device 100 on which the various processing modules will provide their respective presentations, as well as the appearance of each respective display section. Further, the mode selection module 128 can allow a user to select various options that will govern the operation of each invoked processing module.

For instance, the mode selection module 128 can provide a menu that allows the user to activate selected processing modules, select options, choose pairings between processing modules and display sections, configure individual display sections, and so on. Alternatively, or in addition, the mode selection module 128 can present different thumbnail representations of different possible configurations and/or options. The user can select one of these thumbnails to activate the associated configuration and/or options that it represents. For example, in some embodiments, the mode selection module 128 can provide a visual space that conveys various multi-section configuration views, individual section views, configuration options, etc. The user can navigate through this space in any manner, e.g., by making swiping gestures or the like.

In addition, or alternatively, the mode selection module 128 can rely on contextual cues to choose different processing modules, as well as to choose different pairings between processing modules and display sections. As a general principle, the mode selection module 128 can rely on different sensors to determine the environment in which the user is currently operating in. The mode selection module 128 can then invoke any combination of the person space, task space, reference space, etc., which are appropriate for the current environment.

As one consideration, the mode selection module 128 can receive and analyze device-related cues. For example, assume that the user is interacting with the local computing device that lies flat on a table in front of the user. Further assume that the image sensing mechanism(s) 116 cannot capture an adequate representation of the user's face in this orientation. The mode selection module 128 can leverage this evidence to conclude that the user is not interested at this time in interacting with other remote participants via the audio-video conferencing module 124. But then assume that the user picks up the local computing device 100 and holds it in front of him or her in the manner of a paperback book. The mode selection module 128 can now assume that the user is interested in communicating with a remote participant, upon which it activates the audio-video conferencing module 124. The mode-selection module 128 can determine the orientation of the local computing device 100 from an accelerometer and/or a gyro device, etc.

In another use scenario, assume that the user is holding the local computing device 100 like a book. In this case, the mode selection module 128 will activate the audio input mechanism 114 to provide a full A/V experience to the user. Then assume that the user lays the local computing device 100 flat on a table. The mode selection module 128 may deactivate the video component of the A/V experience, but continue to provide the audio component. Further, the mode selection module 128 can invoke the shared workspace processing module 120 to provide the shared workspace, in optional conjunction with reference space information.

In addition, or alternatively, the mode selection module 128 can rely on conversational-related cues to choose different processing modules, as well as to choose different pairings between processing modules and display sections. For example, assume that the local participant is currently discussing a project with a remote participant. Then assume that the depth sensing mechanism of the remote computing device senses that the remote participant has moved a significant distance away from the remote computing device, or perhaps has left the room entirely. The mode selection module 128 can then deactivate the audio-video conferencing module 124 of the local computing device 100.

In another case, the mode selection module 128 can detect more complex cues that indicate that the remote participant is not paying attention to the local participant, or, more generally, which indicate a level or type of participation of the remote participant. For instance, the mode selection module 128 can determine that the remote participant is exclusively talking to another remote participant for a significant amount of time without directing his gaze at the local participant. Or the remote participant may appear to be leaning towards a representation of another remote participant, e.g., as in an attempt to whisper a private comment to the other remote participant. In these cases too, the mode selection module 128 can deactivate the audio-video conferencing module 124 of the local computing device 100 or otherwise place this module in some type of idle state. Or the mode selection module 128 can just shut down the audio-video representation of the remote participant who is not interacting with the local participant, possibly maintaining the audio-video representation of another remote participant. The mode selection module 128 can leverage yet further conversational cues to activate and deactivate processing modules. The mode selection module 128 can receive such cues from any input mechanism or combination of input mechanisms, such as image sensing mechanism(s) 116, audio input mechanism(s) 114, and so on.

In addition, or alternatively, the mode selection module 128 can apply various considerations to arrange the positions of different remote participants on the display surface, establishing a type of virtual meeting. Such factors may take into account the relative (actual) positions of the participants, the flow of conversation among the participants, the rank of the participants within a hierarchy, and so on.

As a final point with respect to FIG. 1, the local computing device 100 may run one or more applications received from any application source or sources. The applications can provide any higher-level functionality in any application domain. Further, the applications can leverage the functionality of the processing engine 118 in various ways, such as by adding new processing modules, modifying existing processing modules, etc.

Advancing now to FIG. 2, this figure shows an illustrative system 200 in which the local computing device 100 of FIG. 1 can be used. In this system 200, the local computing device 100 is in communication with at least one remote participant who operates a remote computing device 202, via a network 204. The network 204 can be implemented by any type of local area network, wide area network (e.g., the Internet), or combination thereof. The network 204 can be physically implemented by any combination of wireless links, hardwired links, name servers, gateways, etc., governed by any protocol or combination of protocols.

The system 200 may also rely on any type of remote services provided by remote computing functionality 206. For instance, the remote computing functionality 206 can maintain shared workspace information and/or other information regarding communication sessions in a data store 208. The remote computing functionality 206 can also provide applications and other functionality that any computing device may utilize, e.g., either by downloading the functionality or utilizing the functionality via a web interface or the like. In another implementation, the remote computing functionality can also implement any (or all) aspect(s) of the processing modules described above. Hence, although this description explained the processing modules as components of the local computing device 100, any of these modules can incorporate functionality provided by some other entity or entities.

Each of the computing devices (100, 202) may also provide local storage, e.g., in data stores 210 and 212. For instance, the local computing device 100 may store a private workspace in the local data store 210. In addition, or alternatively, any user can store his or her personal workspace information at a remote site, such as at the remote computing functionality 206.

The next series of figures show various physical implementations of the local computing device 100 of FIG. 1. It is to be understood that these implementations are presented by way of illustration, not limitation. Other implementations can vary any aspect of the computing devices shown in these figures.

Starting with FIG. 3, this figure shows a local computing device 300 that includes two device parts (302, 304) coupled together via a hinge mechanism 306 of any type, although any other coupling mechanism can be used. Device part 302 includes a display part 308, while device part 304 includes a display part 310, although, in other cases, each device part need not have a corresponding display part. Each device part (302, 304) can also include a speaker (or speakers) for presenting audio information. More generally, any output mechanism(s) can be disposed anywhere on different respective parts of the housing of the local computing device 300.

Further, the local computing device 300 can include different input mechanisms arranged anywhere on different respective parts of the housing of the local computing device 300. (More precisely stated, the local computing device 300 can include different sensors arranged on different parts of the local computing device, where these sensors are associated with respective input mechanisms.) For example, the local computing device 300 can include two input mechanisms 312 on the top of the two device parts (302, 304), two input mechanisms 314 on the bottom of the two device parts (302, 304), two input mechanisms (316, 318) on the side margins of the two device parts (302, 304), and so on. Other implementations can vary these placements in any manner. In one merely illustrative case, the input mechanisms 312 can correspond to video input mechanisms, the input mechanisms 314 can correspond to audio input mechanisms, and the input mechanisms (316, 318) can correspond to depth sensing mechanisms, etc.

More generally, the use of a pair of an image sensing mechanisms on two device parts (or more generally, at two locations on the local computing device 300) creates an image capture volume, such as the illustrative frustum 320. This frustum 320 projects out from the display surface of the local computing device 300 to capture images of objects which lie within the frustum in front of the display surface, or, more generally, in proximity to the local computing device 300. This allows, for instance, the video input mechanism(s) to capture images of the local participant's face (as shown by feature 322), and the depth sensing mechanism(s) to capture images of the local participant's hand gestures, etc. This also allows the stereo sensing input functionality to capture stereo images of objects in front of the display surface, or, more generally, in proximity to the local computing device 300.

In yet another case, the display mechanism 102 can be implemented using bi-directional display technology. In this technology, some of the elements in a display surface can be used to display image content and other elements can be used to capture image content (e.g., via infrared light or the like). In this case, the surface of the display mechanism 102 may itself constitute an image sensing mechanism. This option is particularly effective for capturing hand gestures made by the user in front of the shared workspace.

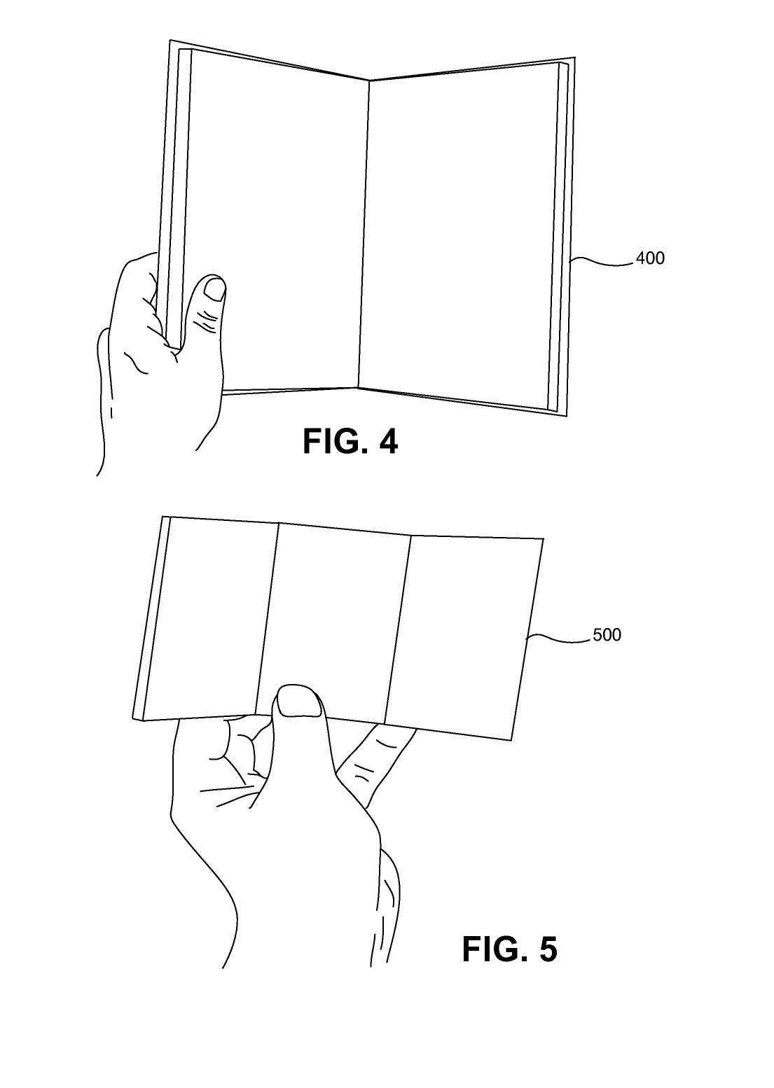

FIG. 4 shows a local computing device 400 that may share all of the above-described features of the local computing device 300 (of FIG. 3), but is larger than the local computing device 300.

FIG. 5 shows a local computing device 500 that includes three device parts (and corresponding display parts), instead of two. In one configuration, the local computing device 500 of FIG. 5 can present audio-video representations of two remote participants on the far left and far right display parts, respectively. The local computing device 500 can devote the middle display part for presenting the shared workspace and the private workspace. Many other arrangements of display sections are possible in such a device.

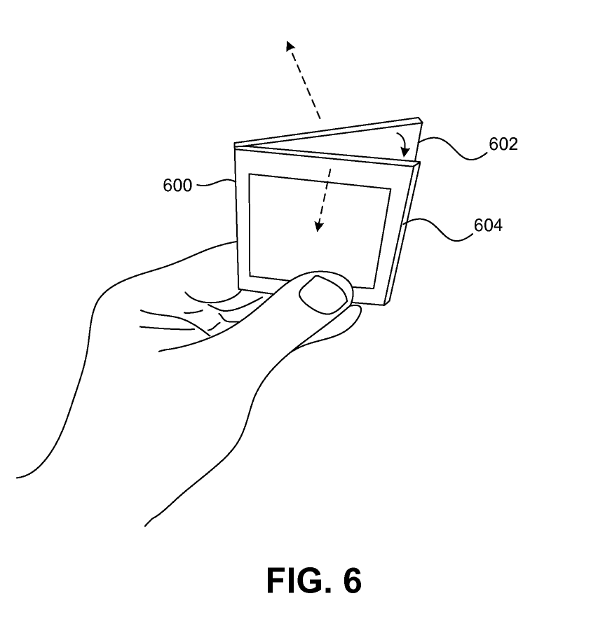

FIG. 6 shows a local computing device 600 that has the same features as the local computing device 300 of FIG. 3. In this case, however, the user has folded a left device part 602 back so that its backside faces a backside of a right device part 604. In this manner, the various image sensing mechanisms disposed on the left display part 602 now project out to capture objects in front of the user (e.g., in the direction that the user is presumed to be facing). That is, the image sensing mechanisms on the left device part 602 point in an opposite direction to the image sensing mechanisms disposed on the right device part 604. In this configuration, the local participant can use the image sensing mechanisms on the left device part 602 to capture the surrounding context in which the local computing device 600 is being used. For example, a depth sensing mechanism on the left device part 602 can be used to sense the distance between the local computing device 600 and objects (e.g., people, landmarks, etc.) in front of the local participant. In another case, any local computing device can include one or more light sensors and/or proximity sensors, etc. on a back of its housing (or at other appropriate location(s)) to detect when the local computing device has been placed on a flat surface.

The next series of figures describe different ways that the presentations furnished by different processing modules can be arranged on different respective display sections. Again, these examples are presented by way of illustration, not limitation. Many other ways exist for mapping presentations to display sections.

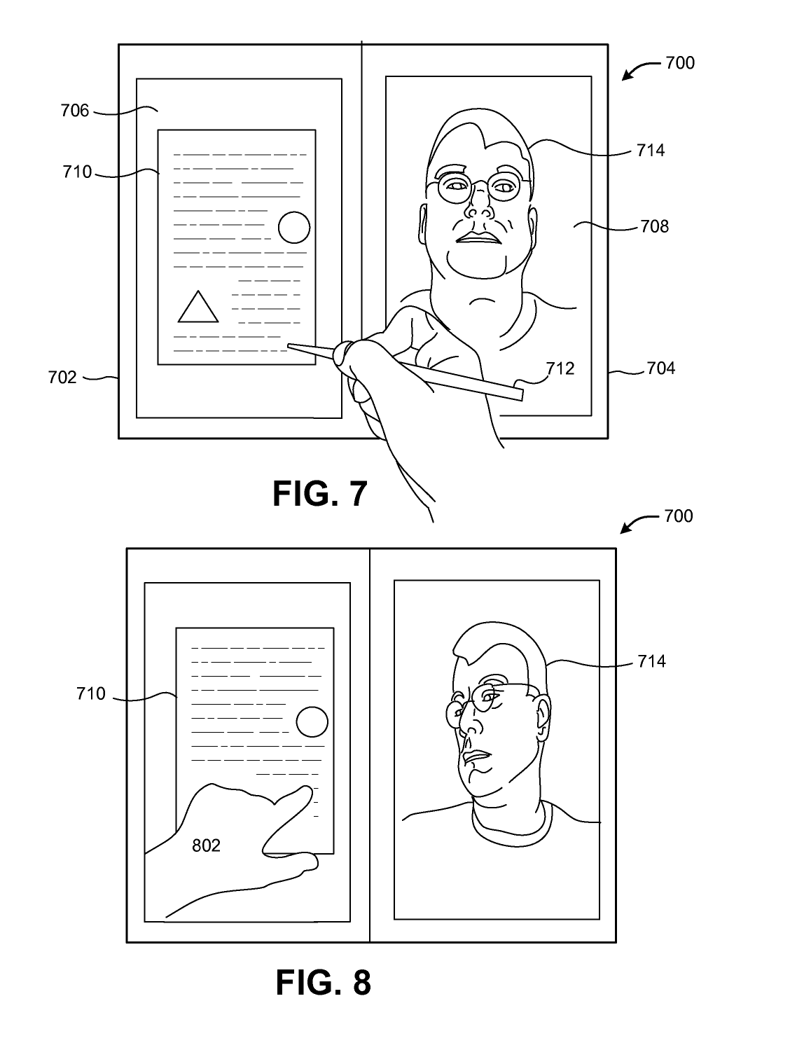

Starting with FIG. 7, this figure shows a local computing device 700 with two device parts (702, 704) and two corresponding display parts (706, 708). The local computing device 700 presents a shared workspace 710 on the first display part 706. A user may interact with the shared workspace 710 in any manner, such as by providing pen input events via a pen device 712. The local computing device 700 presents a video representation 714 of a remote participant on the second display part 708.

FIG. 8 shows the same computing device 700 as FIG. 7. But in this case, a remote user has made a gesture with respect to the shared workspace 710, e.g., by pointing to an object on the shared workspace 710. The reference space module 126 of the remote participant's computer device captures this gesture using a depth sensing mechanism (or other mechanism). The reference space module 126 of the local computing device 700 presents a shadow image 802 of the hand gesture, overlaid on the shared workspace 710. In one case, the reference space module 126 can present the shadow images of different remote participants using different colors and transparency levels to help the local participant understand the association between shadow images and remote participants. Other visual cues can also (or alternatively) be used to distinguish between different shadow images. And as stated above, the reference space module 126 can depict gestures in other ways besides, or in addition to, shadow images.

Also note that, in FIG. 8, the video representation 714 of the remote participant indicates that that participant has turned his gaze away from the local participant, e.g., insofar as this remote participant appears to be looking off to the side. Perhaps this remote participant is looking at another remote participant who is in the same room with him. Or perhaps this remote participant is looking at the shared workspace 710. This is assuming that the actual relation between the remote participant and the shared workspace mirrors the relation depicted in FIG. 8. These types of cues facilitate human-to-human communication. Further, the mode selection module 128 can leverage visual (and related audio) cues of this nature to potentially deactivate the representation of this remote participant.

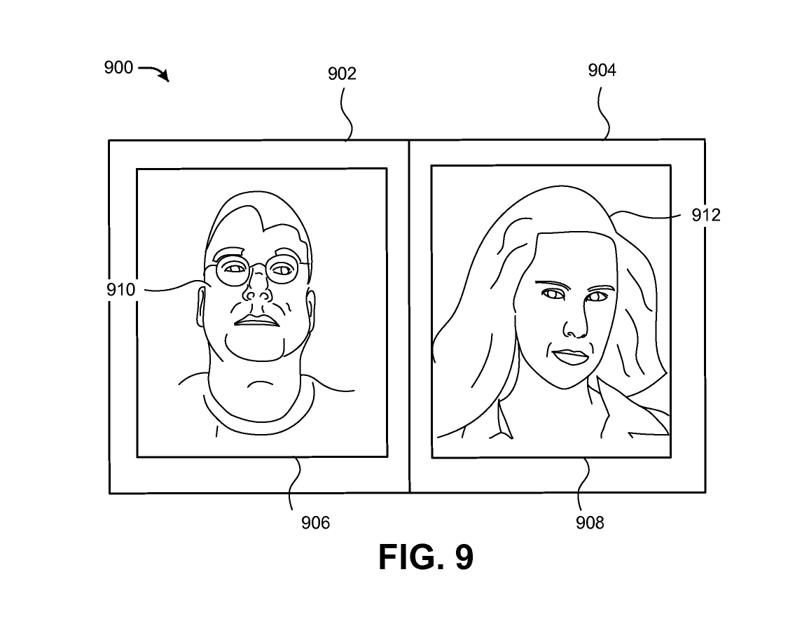

FIG. 9 shows another local computing device 900 that has two device parts (902, 904) and two corresponding display parts (906, 908). In this case, the local computing device 900 presents a video representation 910 of a first remote participant on the left display part 906 and a video representation 912 of a second remote participant on the right bottom display part 908. The voice of the left participant can be presented via a speaker (not shown) provided in the left device part 902. The voice of the right participant can be presented via a speaker (not shown) provided in the right device part 904.

Although not shown, a user may alternatively hold the local computing device 900 in a portrait mode, rather than in a landscape mode (as in the case of FIG. 9). In this case, the local computing device 900 can sense a change in the orientation of the local computing device 900 (e.g., based on input events provided by any movement sensing mechanism(s)). The mode selection module 128 of the local computing device 900 can then automatically rotate the content that it displays to accommodate the new orientation.

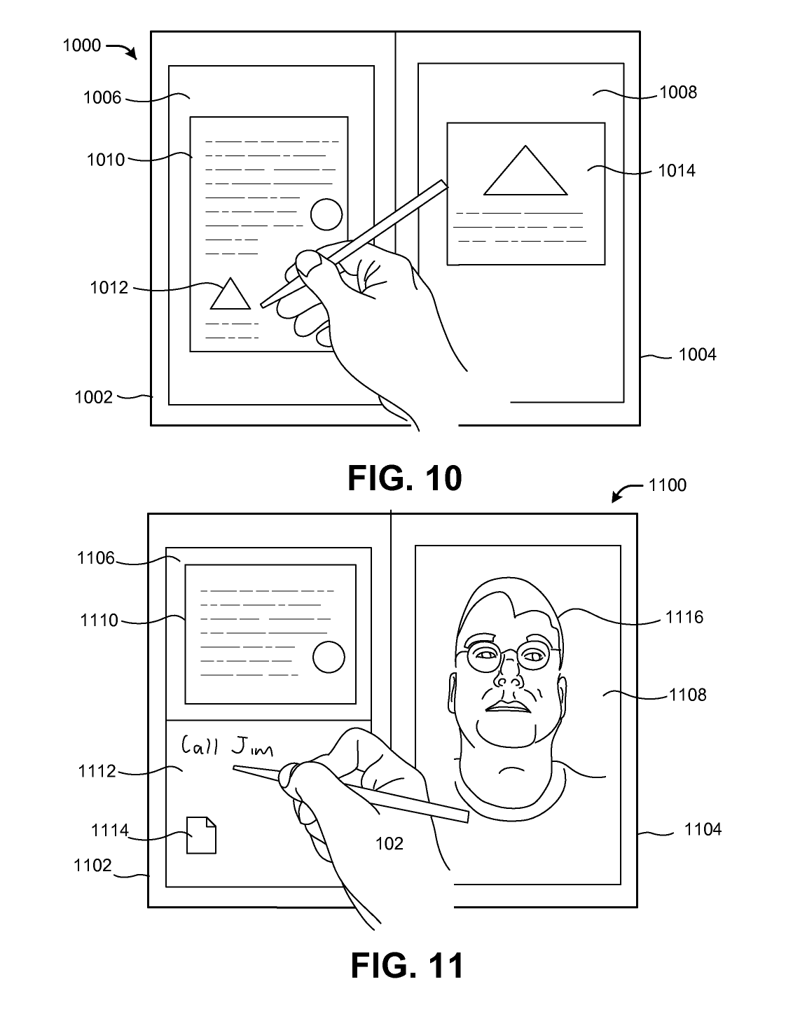

FIG. 10 shows another local computing device 1000 that includes two device parts (1002, 1004) and two corresponding display parts (1006, 1008). The local computing device 1000 presents a shared workspace 1010 on the left display part 1006. In this case, assume that the user has selected a particular object 1012 (e.g., a link or the like) in the shared workspace 1010, e.g., by tapping on this object 1012 with a pen device or finger, etc. In one implementation, the local computing device 1000 can respond to this action by opening up the content 1014 associated with the object 1012 and presenting that content 1014 on the right display part 1008.

FIG. 11 shows another local computing device 1100 that includes two device parts (1102, 1104) and two corresponding display parts (1106, 1108). The local computing device 1100 presents a shared workspace 1110 on a top display section of the left display part 1106. The local computing device 1100 presents a private workspace 1112 on a bottom display section of the left display part 1106. The shared workspace 1110 is shared among participants while the private workspace 1112 is dedicated for exclusive use by the local participant (and is not revealed to remote participants). The local participant can use the private workspace 1112 to take notes, to view private documents or other information, or perform other private tasks. However, the local participant can move any object(s) (such as object 1114) in the private workspace 1112 to the shared workspace 1110, after which that object 1114 can be viewed and/or manipulated and/or modified by other participants, presuming that the local participant has given appropriate permissions to manipulate and/or modify the object 1114. The local participant can also drag objects from the shared workspace 1110 into the private workspace 1112. The right display part 1108 again presents a video representation 1116 of a remote participant.

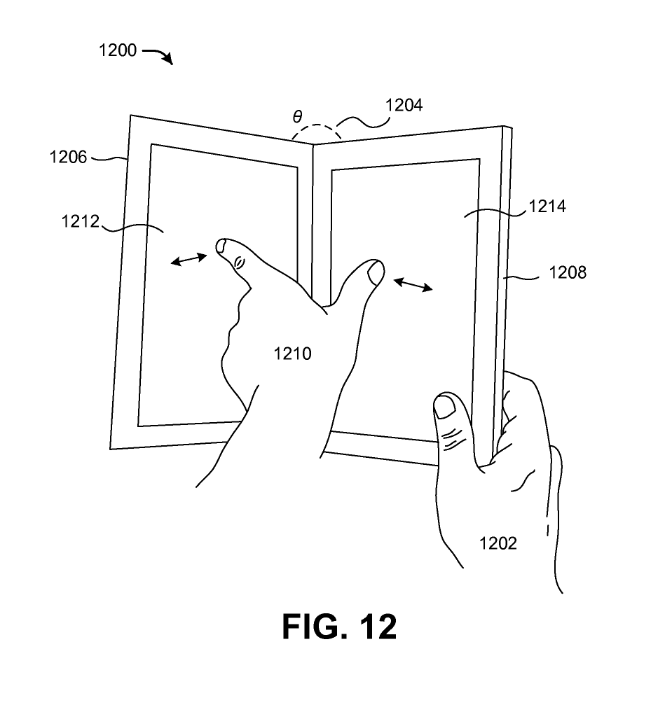

A local computing device having plural display parts (and corresponding display sections) can accommodate new gestures that involve plural display sections. FIG. 12 shows one such gesture. Here, the user holds a local computing device 1200 in a right hand 1202, with an angle 1204 defined between its two device parts (1206, 1208). The user then uses an index finger and a thumb of his left hand 1210 to touch the two display parts (1212, 1214) of the local computing device 1200. The local computing device 1200 can interpret this touching gesture alone as a meaningful command. The user can create more complex gestures by combining the illustrated multi-touch gesture with other operations. For example, the user can change the position of his finger and thumb on the display surface and/or change the angle 1204 between the device parts (1206, 1208). Each of these movements can correlate to distinct commands of any nature. The local computing device 1200 can detect a change in rotation between the device parts (1206, 1208) based on any rotational sensor(s), such as a flex sensor, an optical encoder mechanisms, etc.

In one use scenario, the mode selection module 128 (of FIG. 1) can use the gesture shown in FIG. 12 to allow a user to navigate among configuration selections. Namely, the user can apply the touch gesture shown in FIG. 12 while rotating the device parts (1206, 1208), or the user can apply the touch gesture shown in FIG. 12 for a predetermined time (upon which the appropriate gesture mode is established), then remove the touch gesture, and then rotate the device parts (1206, 1208). The rotation prompts the mode selection module 128 to sequence through various configuration options. Or the mode selection module 128 can present a comprehensive list of options (all at once), and the user can select a desired option.

In another case, the local computing device 1200 can use the gesture shown in FIG. 12 to advance through different layers of content, such as a slide presentation having a series of slides. That is, the computing device 1200 moves through the layers as the user rotates the device parts (1206, 1208). This allows a user to conveniently find particular object(s) within a collection of objects, upon which the user can take any action on the object(s).

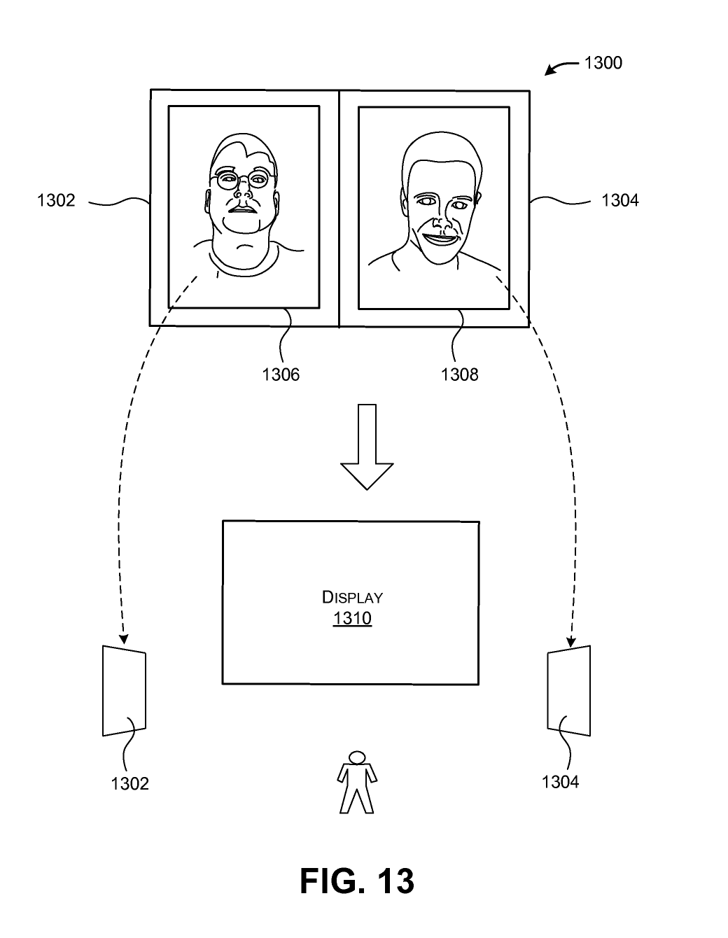

Advancing to FIG. 13, this figure shows another local computing device 1300 that includes two device parts (1302, 1304) and two corresponding display parts (1306, 1308). This local computing device 1300 also includes a coupling mechanism that enables the device parts (1302, 1304) to be separated. For example, the coupling mechanism can use sliding members, screws, clasps, VELCO® fasteners, snapping members, latches, etc., or any combination thereof, to couple the device parts (1302, 1304) together in a detachable manner.

In one case, each device part (1302, 1304) can include a self-sufficient suite of processing functionality that enables it to operate when separated from its counterpart device part. For example, each device part can include any (or all) of the processing modules shown in FIG. 1, together with an independent processing unit (e.g., a CPU), memory resource, battery source, communication functionality, etc. Alternatively, the two device parts (1302, 1304) may not include identical functionality. In this case, for example, one (or more) device parts can use a resource or resources of other device part(s), e.g., via any type of local coupling between device parts.

In one case, each device part (1302, 1304) can take part in an interactive session in the manner of an independent computing unit. Alternatively, or in addition, a centralized module (e.g., which may be provided at the remote computing functionality 206 and/or at a local location) can coordinate operation of the plural device parts (1302, 1304). In yet another case, one of the device parts can assume the role of master, and so on.

In the use scenario of FIG. 13, the user has placed the two detached device parts (1302, 1304) on either side of a larger display 1310, such as a computer monitor, a wall display, etc. In one case, these three units are indirectly coupled together via their mutual interaction with some central entity, such as the remote computing functionality 206. Alternatively, or in addition, these three units can be coupled together in a local manner (e.g., by local cables and/or wireless links, etc.) In one application, the two device parts (1302, 1304) can present visual representations of two remote participants, while the display 1310 can present a depiction of a shared workspace (however, more generally, different spaces can be allocated to different detached device parts (1302, 1304) in any manner, including a situation in which one device part displays two or more spaces). At any time the user can rejoin the device parts (1306, 1308), such as when the user is finished with the interactive session, or even in the course of the interactive session.

FIG. 14 shows a local computing device 1400 that has three detachable device parts (1402, 1404, and 1406). In one use case, the user can decouple these device parts (1402, 1404, and 1406) and arrange them in the manner shown in FIG. 14. The device parts 1402 and 1406 can present visual representations of two remote participants, while the middle device part 1404 can present a shared workspace or a representation of a third remote participant (not shown) (however, more generally, different spaces can be allocated to different detached device parts (1402, 1404, 1406) in any manner, including a situation in which one device part displays two or more spaces). In addition, or alternatively, the middle device part 1404 (or any device part(s)) can include one or more projection modules (not shown); for example, a projection module can project an image of the shared workspace (and/or a private workspace, and/or any other content) on a table or a wall. The local participant (user) can arrange the other device parts with respect to this projection in any manner deemed conducive to interactive communication.

Generally, the modular approach shown in FIGS. 13 and 14 also provides an extensible design. That is, a user can enhance the functionality of a computing device at any time by acquiring another device part and attaching that device part to the existing device parts. Similarly, the user can remove a device part (or parts) at any time to simplify the computing device.

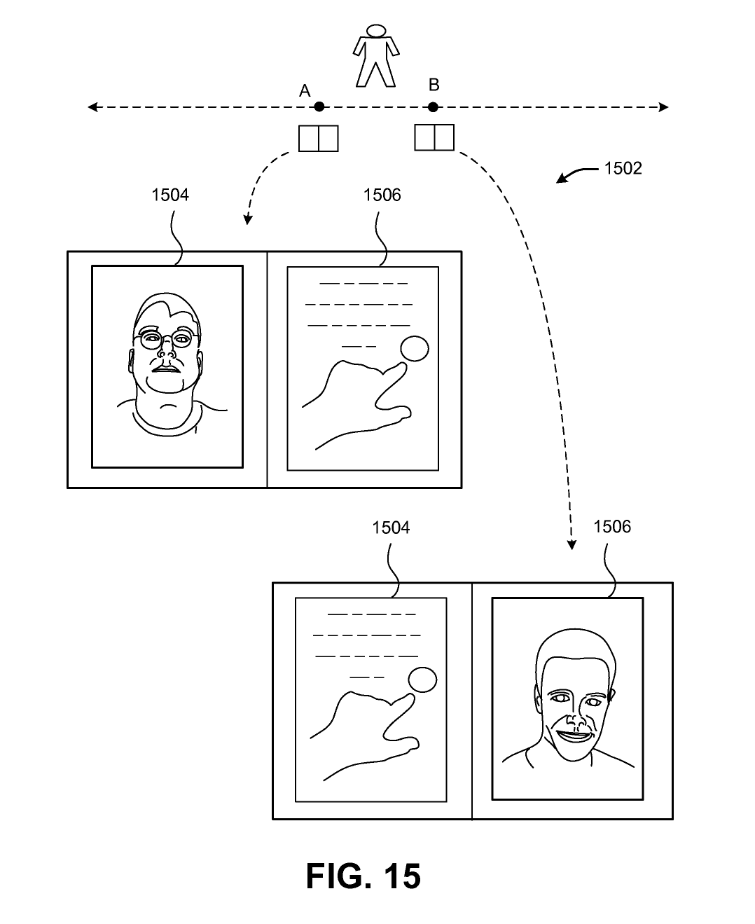

FIG. 15 illustrates another manner of operation of the mode selection module 128 (of FIG. 1). In this case, the mode selection module 128 can include one or more position determination mechanisms which can determine the relative and/or absolute placement of a local computing device 1502 or any part(s) of the local computing device 1502. Namely, in one example, assume that the user holds the local computing device 1502 out in front of him or her and shifts it laterally from position A to position B. More generally, the user can move the computing device 1502 along any path, including a curved path, or a path that involves rotation of the computing device 1502 (with or without translational movement), etc. The position determination mechanism(s) can determine this shift through various means, such as using accelerometers, gyro devices, etc. Alternatively, or in addition, the position determination mechanism(s) can determine this shift through various wireless position-detection strategies (e.g., triangulation, proximity to a Wi-Fi source, etc.).

In response to this shift, the mode selection module 128 can toggle the content (e.g., spaces) presented on the display parts (1504, 1506) in any manner. For example, at position A, the mode selection module 128 presents a visual representation of a first remote participant on display part 1504, and a depiction of a shared workspace on the display part 1506. At position B, the mode selection module 128 presents the shared workspace on the display part 1502 and a depiction of a second remote participant on the display part 1506. In effect, the scenario of FIG. 15 duplicates the content of the scenario of FIG. 14, but the experience in the case of FIG. 15 involves the user to moving the local computing device 1502 to advance to different views of the content. In one implementation, a user can enter a command to advance from the mode shown in FIG. 15 to dual-participant mode shown in FIG. 9, or any other mode shown in the preceding figures (for example).

B. Illustrative Processes

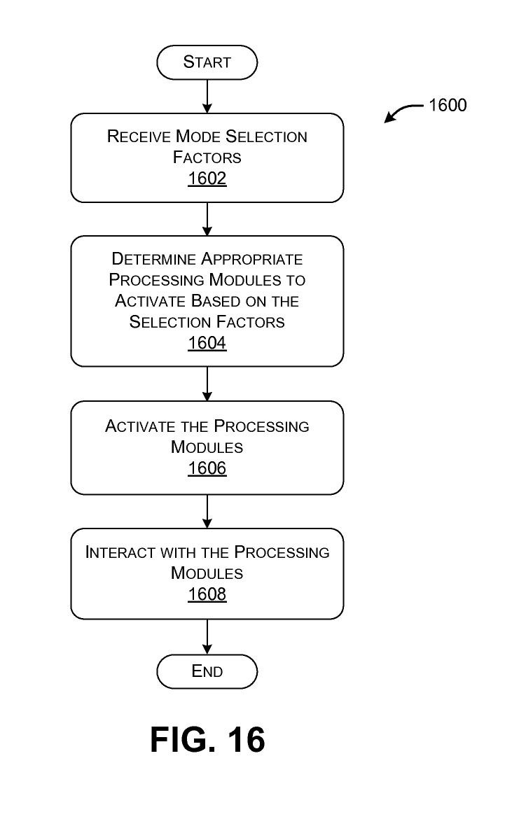

FIG. 16 shows a procedure 1600 that explains one manner of operation of the local computing device 100 of FIG. 1. Since the principles underlying the operation of the local computing device 100 have already been described in Section A, certain operations will be addressed in summary fashion in this section. Any remote computing device operates in a complementary way.

In block 1602, the local computing device 100 receives mode selection factors which govern which processing modules are to be activated, as well as the mappings between processing modules and display sections. Illustrative selection factors were set forth in Section A. They can include express selections made by the user, device-related contextual cues, conversational cues, and so on.

In block 1604, the local computing device 100 determines a set of appropriate processing modules to invoke based on the selection factors. In block 1606, the local computing device 100 activates those processing modules. In block 1608, the local participant interacts with those processing modules to conduct an interactive session with one or more remote participants.

C. Representative Processing Functionality

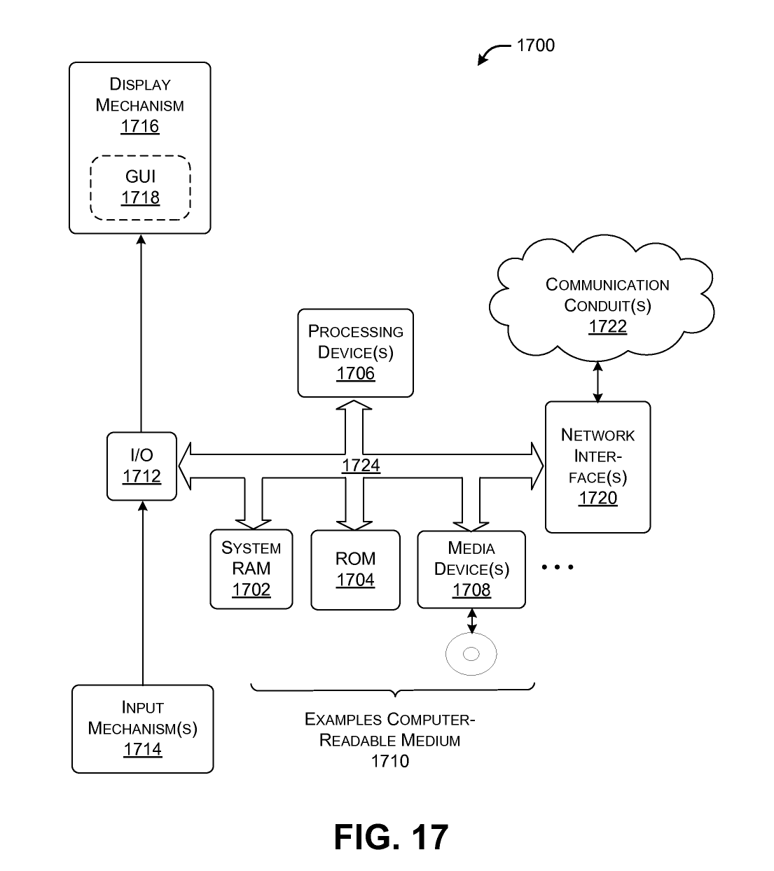

FIG. 17 sets forth illustrative electrical data processing functionality 1700 that can be used to implement any aspect of the functions described above. With reference to FIG. 1, for instance, the type of processing functionality 1700 shown in FIG. 17 can be used to implement any aspect of the local computing device 100. In one case, the processing functionality 1700 may correspond to any type of computing device that includes one or more processing devices. In all cases, the electrical data processing functionality 1700 represents one or more physical and tangible processing mechanisms.

The processing functionality 1700 can include volatile and non-volatile memory, such as RAM 1702 and ROM 1704, as well as one or more processing devices 1706. The processing functionality 1700 also optionally includes various media devices 1708, such as a hard disk module, an optical disk module, and so forth. The processing functionality 1700 can perform various operations identified above when the processing device(s) 1706 executes instructions that are maintained by memory (e.g., RAM 1702, ROM 1704, or elsewhere).

More generally, instructions and other information can be stored on any computer readable medium 1710, including, but not limited to, static memory storage devices, magnetic storage devices, optical storage devices, and so on. The term computer readable medium also encompasses plural storage devices. In all cases, the computer readable medium 1710 represents some form of physical and tangible entity.

The processing functionality 1700 also includes an input/output module 1712 for receiving various inputs from a user (via input mechanisms 1714), and for providing various outputs to the user (via output modules). One particular output mechanism may include a display mechanism 1716 (which can include two or more display parts) and an associated graphical user interface (GUI) 1718. The processing functionality 1700 can also include one or more network interfaces 1720 for exchanging data with other devices via one or more communication conduits 1722. One or more communication buses 1724 communicatively couple the above-described components together.

The communication conduit(s) 1722 can be implemented in any manner, e.g., by a local area network, a wide area network (e.g., the Internet), etc., or any combination thereof. The communication conduit(s) 1722 can include any combination of hardwired links, wireless links, routers, gateway functionality, name servers, etc., governed by any protocol or combination of protocols.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A local computing device operated by a local participant to an interaction session, comprising:
a display mechanism that provides a display surface, the display mechanism including at least two display parts provided on two respective device parts;
plural input mechanisms for receiving input events; and
a processing engine that includes plural processing modules for delivering respective functionalities, including:
a shared workspace processing module configured to provide a shared workspace, the shared workspace being shared by at least two participants to the interaction session;
an audio-video conferencing module configured to capture an audio-video representation of the local participant, and to display an audio-video representation of a remote participant of the interaction session; and
a reference space module configured to capture a gesture representation of local hand gestures made by the local participant in proximity to the display surface, and to display a gesture representation of remote hand gestures made by the remote participant in proximity to a remote display surface associated with a remote computing device operated by the remote participant,
the local computing device being configured to display the shared workspace and audio/visual representation of the remote participant on the display surface.

2. The local computing device of claim 1, wherein the computing device is a handheld computing device.

3. The local computing device of claim 1, wherein said at least two device parts are attached to each other via a coupling mechanism.

4. The local computing device of claim 3, wherein the coupling mechanism is a detachable coupling mechanism that is configured to allow said at least two display parts to be separated.

5. The local computing device of claim 1, wherein said at least two device parts comprise at least three device parts.

6. The local computing device of claim 1, wherein the local computing device is configured to display the shared workspace and audio/visual representation of the remote participant on different display sections of the local computing device.

7. The local computing device of claim 1, wherein the local computing device is configured to display the gesture representation of the remote hand gestures overlaid on the shared workspace, as presented to the local participant.

8. The local computing device of claim 1, wherein the plural input mechanisms include a depth sensing mechanism for sensing distance of objects from the local computing device.

9. The local computing device of claim 1, wherein the plural input mechanisms include a stereo sensing mechanism for providing stereo images of objects in proximity to the local computing device.

10. The local computing device of claim 1, wherein the plural input mechanisms comprise at least one image sensing mechanism, wherein said at least one image sensing mechanism defines a capture frustum of the local computing device that projects out from the local computing device.

11. The local computing device of claim 1, further including a depth sensing mechanism, wherein the local computing device is configured such that the depth sensing mechanism can be aimed in a direction opposite to at least one part of the display surface that faces the local participant.

12. The local computing device of claim 1, wherein the processing engine further comprises a private workspace processing module for presenting a private workspace for private use by the local participant.

13. The local computing device of claim 12 wherein the private workspace processing module is configured to permit the local participant to move objects from the private workspace to the shared workspace.

14. The local computing device of claim 1, wherein the processing engine further comprise a mode selection module for selecting one or more processing modules that are activated at each identified time of operation.

15. The local computing device of claim 14, wherein the mode selection module determines said one or more processing modules that are activated based at least in part on at least one of an orientation and position of the local computing device.

16. The local computing device of claim 14, wherein the mode selection module determines said one or more processing modules that are activated based at least in part on an assessed level of participation by the remote participant.

17. A method of operation of a local computing device operated by a local participant of an interaction session, the local computing device including a display mechanism that provides a display surface, the display mechanism including at least two display parts provided on two respective device parts, the method comprising:
receiving mode selection factors;
using the mode selection factors to determine one or more appropriate processing modules to be activated;
activating said one or more processing modules determined to be appropriate, the processing modules selected from among:
a shared workspace processing module configured to provide a shared workspace, the shared workspace being shared by at least two participants to the interaction session;
a audio-video conferencing module configured to capture an audio-video representation of the local participant, and to display an audio-video representation of a remote participant of the interaction session; and
a reference space module configured to capture a gesture representation of local hand gestures made by the local participant in proximity to the display surface, and to display a gesture representation of remote hand gestures made by the remote participant in proximity to a remote display surface associated with a remote computing device operated by the remote participant; and
conducting the interaction session by interacting with the processing modules that have been activated.

18. The method of claim 17, wherein the mode selection factors include one or more of:
express commands received from the local participant;
a position of the local computing device;
an orientation of the local computing device; and
an assessed level of participation by the remote participant.

19. A computer readable medium for storing computer readable instructions, the computer readable instructions providing a processing engine having a plurality of processing modules, the processing modules comprising:
a shared workspace processing module configured to provide a shared workspace, the shared workspace being shared by at least two participants of an interaction session, including a local participant who operates a local computing device and a remote participant who operates a remote computing device;
a private workspace processing module for presenting a private workspace for private use by the local participant;
an audio-video conferencing module configured to capture an audio-video representation of the local participant, and to display an audio-video representation of the remote participant;
a reference space module configured to capture a gesture representation of local hand gestures made by the local participant in proximity to a display surface of the local computing device, and to display a gesture representation of remote hand gestures made by the remote participant in proximity to a remote display surface associated with the remote computing device; and
a mode selection module for selecting which processing modules are activated at each identified time of operation.

20. The computer readable medium of claim 19, wherein the mode selection module determines which processing modules are activated based at least on an assessed level of participation by the remote participant.
